(19) United States
(12) Patent Application Publication
(10) Pub. No.: US 2018/0027435 A1
(43) Pub. Date: Jan. 25, 2018

(54) METHOD FOR TESTING CLIENT ROAMING

(71) Applicant: KONINKLIJKE PHILIPS N.V., EINDHOVEN (NL)

(72) Inventor: John HARROD, NORTH ANDOVER, MA (US)

(21) Appl. No.: 15/546,768

(22) PCT Filed: Jan. 29, 2016
(86) PCT No.: PCT/IB2016/050447

§ 371 Date: Jul. 27, 2017

Related U.S. Application Data
(60) Provisional application No. 62/112,694, filed on Feb. 6, 2015.

(51) Int. Cl. H04W 24/06; H04W 36/30; H04W 36/16; H04W 36/08; H04W 48/16

(52) U.S. Cl. CPC H04W 24/06; H04W 36/08; H04W 48/16; H04W 36/165; H04W 36/30; H04W 84/12

(57) ABSTRACT

The following relates to roam test systems and methods. By way of illustrative example, in a wireless network, a device under test (DUT) may be connected to an access point (AP). The DUT may switch which AP the DUT is connected to, thereby triggering a roam event. It is desirable to gather large amounts of data related to roam events. In the systems described herein, a plurality of roam events may be triggered to gather such data. Roam events may be triggered by, for example, deactivating all but an active AP of a plurality of APs, or by reducing or increasing a transmit power of an AP or APs, or so forth.

### BACKGROUND

The following relates to the wireless device testing arts, wireless communication network arts, device roaming arts, and related arts.

In a typical wireless electronic communication network, a device may be connected to a network through a wireless access point (AP) in the network. APs are typically controlled by a wireless local area network controller (WLC). In order to cover a sizable area, such as a floor or several floors of a building, the network may have many APs, and the APs are often wireless routers. As the device travels geographically farther away from an AP that the device is connected to (for example, because a person carrying the device is walking), the connection between the device and the AP may become weaker, and may eventually be lost. Therefore, in certain circumstances, a device may switch from being connected to one AP to another, which is called roaming; and the event in which a device switches from one AP to another is called a roam event (sometimes also referred to as “handoff” of the device from one AP to another).

However, as a practical matter, technical problems are known to occur during roaming (e.g. due to a chip defect or so forth). Additionally, even in networks where roaming normally occurs without error, there may be problems during a small percentage of roam events. The performance of roaming may be improved by setting various configuration parameters of the wireless device and/or the APs. Therefore, to detect intrinsic defects, to optimize configuration parameters, or so forth, it is desired to gather test data related to roaming.

Roaming system reliability is of particular importance in the context of wireless medical monitoring devices. An example of such a device is the IntelliVue MX40™ wearable patient monitor (available from Koninklijke Philips N. V., Eindhoven, the Netherlands). The MX40™ is worn by a patient, for example in a pouch that is hung around the patient's neck, and supports patient physiological sensors including electrocardiograph (ECG) and pulse oximetry (SpO₂) sensors. The wireless connectivity of the MX40™ allows the patient to be ambulatory while remaining continuously monitored at the nurses' station or another central monitoring location. Due to the life-critical nature of ECG and other physiological sensors, a loss of wireless connectivity with the patient monitor (for example, due to a failed roam event) may set off an alarm at the nurses' station calling for the patient be quickly located to assess whether a medically significant event is occurring. Maintaining reliable (ideally failure-free) wireless communication with the wireless medical monitor is made more difficult by the challenging wireless environment of a typical hospital, which commonly includes multiple wireless networks for various purposes which are connected with myriad wireless devices. Accordingly, communications testing of the wireless medical monitor should be rigorous, including acquiring statistics for a large number of roam events. For example, a typical stress test preferably includes several thousand roam events.

One known method for testing a device while roaming, known as the “walk-around” test, is to physically walk the device through the network. However, this is time consuming and does not provide very much data. Stress testing the device using walk-around testing is particularly challenging. Other test methods employ special equipment to force or simulate a roam event. For example, a shield or antenna attenuator may be used to weaken the signal of an AP, thereby triggering a roam event. However, this requires additional special equipment, is time consuming, and again does not provide very much data.

### SUMMARY

In accordance with one aspect, a non-transitory storage medium storing instructions readable and executable by a computer in communication with a wireless local area network controller (WLC) controlling a plurality of wireless access points (APs) to perform a roam test method including the operations of: (i) deactivating all but an active AP of the plurality of APs; (ii) connecting a wireless medical device under test (DUT) with the active AP; and (iii) triggering a roam event by operations including: connecting the DUT with a second AP that is different from the active AP of operation (i); and making the second AP the active AP.

In accordance with another aspect, a roaming test method, comprising: (i) deactivating all but an active wireless access point (AP) of a plurality of APs; (ii) connecting a wireless medical device under test (DUT) with the active AP; and (iii) triggering a roam event including: connecting the DUT with a second AP of the plurality of APs that is different from the active AP of operation (i); and deactivating the active AP of operation (i) thereby making the second AP the active AP.

In accordance with yet another aspect, a wireless medical communication test system comprising: a plurality of wireless access points (APs); a wireless medical device under test (DUT) configured to send and receive information via the plurality of APs using Institute of Electrical and Electronic Engineers (IEEE) 802.11 compliant communication, and further configured to log roam information; a wireless local area network controller (WLC) configured to control the plurality of APs; and a computer configured to control the WLC to perform operations including: through the WLC, deactivate all APs of the plurality of APs except an active AP of the plurality of APs whereby the DUT connects with the active AP; through the WLC, controlling the APs to trigger a roam event in which the DUT hands off from the active AP to a second AP different from the active AP; and storing information on the triggered roam event acquired from at least one of the DUT and the WLC.

One advantage of the approaches described herein is to gather roaming test data without the use of special equipment and without moving the wireless mobile device under test.

Another advantage is that large amounts of data may be gathered. Put another way, data for stress testing (e.g. where data for several thousand roam events is desired) may be gathered.

Yet another advantage is gathering data in a short period of time.

The invention may take form in various components and arrangements of components, and in various steps and arrangements of steps. The drawings are only for purposes of illustrating the preferred embodiments and are not to be construed as limiting the invention.

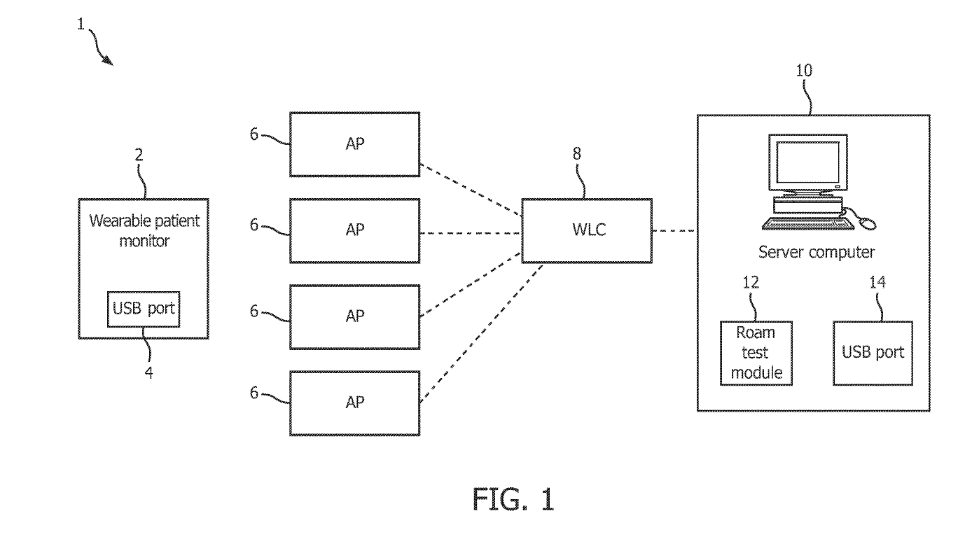

FIG. 1 diagrammatically shows a wireless medical communication test system in the context of a medical facility.

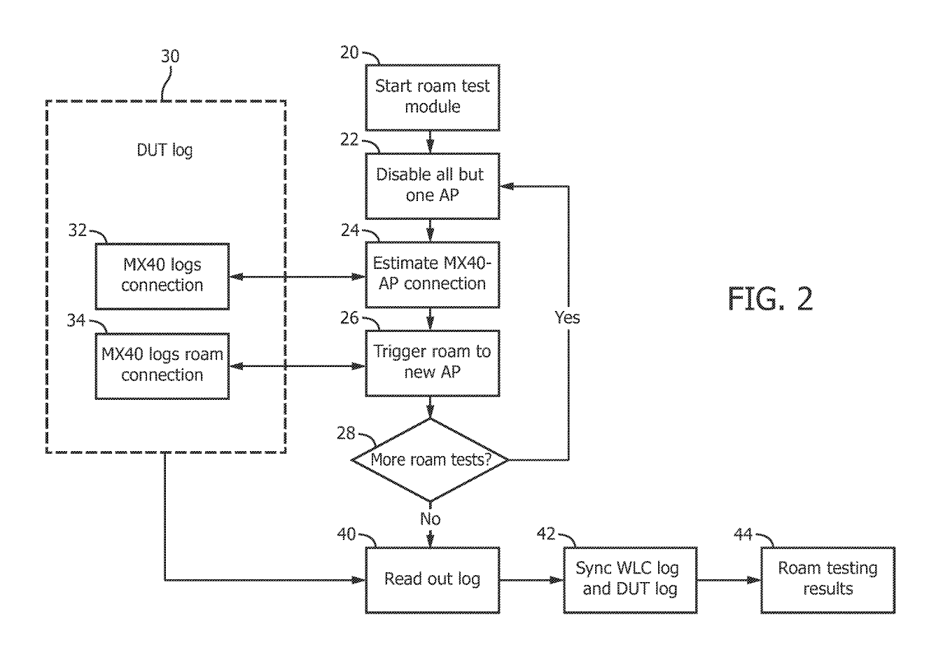

FIG. 2 diagrammatically shows an example of a roam test method performed using the test system of FIG. 1.

### DETAILED DESCRIPTION

Disclosed herein are approaches for testing the roaming characteristics of a wireless medical device under test (DUT) operating in a wireless communication system. The disclosed approaches advantageously do not require any special equipment, such as radio frequency shields or antenna attenuators, and do not entail moving the DUT from proximity to one wireless access point (AP) to proximity to another AP. Rather, the disclosed approaches are readily computer-implementable, and entail controlling the wireless local area network (LAN) controller (WLC) in order to selectively activate and deactivate APs in order to cause handoff of the DUT from one AP to another. The activation/deactivation of an AP can be performed by enablement/disablement, in which the AP is effectively turned on/off.

Alternatively, the activation/deactivation of an AP can be performed by adjusting transmit power of the AP. By reducing transmit power of the AP, movement of the DUT away from the AP is simulated (although the DUT actually remains stationary). Conversely, by increasing transmit power of the AP movement of the DUT toward the AP is simulated (although again, the DUT actually remains stationary). This approach to performing the roaming testing therefore enables testing of the impact of DUT and AP configuration parameters on the roaming performance—for example, it can be determined at what power level (or relative power level) a handoff is triggered, or at what power level communication is completely lost.

The disclosed approaches can be implemented by a computer in communication with the WLC (for example, the server computer controlling the WLC) in order to control the APs. Under conventional wireless electronic data communication protocols such as the IEEE 802.11 standard, data on the roam events is conventionally stored in wireless communication logs—at both the WLC and the DUT. These logs are suitably acquired by the computer, via its communication link with the WLC or by physically connecting the DUT with the computer during or after the roam testing (e.g. using a physical USB cable) in order to acquire roam statistics or the like.

It should be noted that the disclosed techniques generally cannot be performed in an operational hospital setting, because the APs cannot be used for normal wireless communication traffic during the testing, and it is usually not practical to take the APs of a hospital network offline to perform the testing. However, the disclosed techniques can be used in a “testbed” setting, for example to test performance of the wireless communication sub-system of a wireless medical device using a dedicated “testbed” wireless network. The disclosed techniques are also contemplated to be employed in an actual hospital setting, either at a time when the hospital is not actively operating (e.g. testing the wireless communication network of a new hospital before it begins serving patients) or by taking a portion of the hospital network offline (e.g., it is envisioned to test the wireless network of a single floor, care unit, or the like using the disclosed techniques by taking only the APs of that single floor, care unit, etc. offline for the testing).

With reference to FIG. 1, medical facility network 1 includes wearable patient monitor 2. The wearable patient monitor 2 is capable of wirelessly connecting to any of a plurality of wireless access points (APs) 6. The wearable patient monitor 2 gathers data of a patient, for example, physiological data such as electrocardiogram (ECG) data, SpO₂ data, or so forth may be gathered. The wearable patient monitor 2 may also include a touchscreen to enable easy viewing of the gathered data, as well as other information such as alarm history and alarm settings. It is contemplated for the wearable patient monitor 2 to provide other functionality, such as audio or audio/video communication with a nurses' station (e.g. enabling the patient to press a “talk” button to talk with his or her nurse). The wearable patient monitor 2 optionally includes a USB port 4 or other physical data communication port(s) for the purpose of transferring data (e.g. to a server computer 10 through a USB cable, not shown, connecting USB port 4 of the wearable patient monitor 2 with USB port 14 of the computer 10). An example of wearable patient monitor 2 is the IntelliVue MX40™ (available from Koninklijke Philips N. V., Eindhoven, the Netherlands).

By way of the MX40™ as an illustrative example, patient monitor 2 is designed to be placed in a pouch supported from the patient's neck, and can be connected with various patient monitoring sensors (e.g. ECG electrodes). The patient monitor 2 communicates with a central station (usually the nurses' station) wirelessly using a proprietary wireless network or using an available wireless local area network (WLAN) (e.g., an Institute of Electrical and Electronics Engineers (IEEE) 802.11 wireless network). Because life-critical data are being communicated, the communication link needs to be reliable. If the wireless link drops out, the patient monitor 2 alarms and an alarm issues at the nurses' station, and the ambulatory patient must be tracked down to determine the cause of the alarm. Accordingly, it is desirable to thoroughly test the wireless communication system including the patient monitor 2 and its connection with the APs 6. Since roam event anomalies are a common failure mode in distributed wireless communication systems, it is of particular value to test roaming performance, preferably including performing so-called “stress tests” in which many roam events, e.g. 2000-3000 roam events in some test protocols, are performed in order to collect sufficient statistics.

Returning to FIG. 1, the plurality of APs 6 are controlled by a wireless local area network (LAN) controller (WLC) 8. The WLC 8 is in turn controlled by the server computer 10. For example, in a typical hospital setting, electronic hospital services (e.g. admissions records, electronic patient records, and so forth) are maintained on the hospital server 10, and communication amongst personal computers, tablet or slate computers, or other devices throughout the hospital connect with the server 10 via the LAN by wireless connectivity provided by the wireless LAN comprising the APs 6 and WLC 8. Additionally, some stationary devices such as desktop computers may additionally or alternatively connect with the server computer 10 via a wired LAN such as a wired Ethernet (not shown in FIG. 1). The diagrammatically indicated server computer 10 may actually comprise various configurations or architectures of interconnected/distributed computing resources. For example, the server may be partially or wholly cloud-based, comprising computers interconnected via the LAN and possibly also via the Internet. Conventionally, Information Technology (IT) personnel maintain the wireless local area network, including operations such as configuring parameters of the APs 6 and WLC 8, by interaction with the WLC 8 via the server computer 10.

To implement the disclosed roam testing techniques, the server computer 10 further includes a roam test module 12, which may for example comprise a script or other software readable and executable by the server computer 10 to perform the roam testing method described in FIG. 2. It is alternatively contemplated to implement the roam test module 12 on another computer (not shown) that is in communication with the WLC 8, either directly or indirectly via connection with the server computer. The computer running the roam test module 12 (whether the server computer 10 as illustrated, or another computer in communication with the WLC 8) is capable of controlling the WLC 8 in order to control the APs 6, for example by turning APs on or off (also referred to herein as “enabling” or “disabling” the APs), and/or by setting transmit power for an AP. It is also contemplated for the control to extend to other parameters of the wireless communication system such as setting the operating frequency used by an AP, setting other communication protocol parameters, or so forth.

With reference to FIG. 2, an illustrative roam testing method is described, which is suitably performed by the system of FIG. 1, and in particular by execution of the script or other software implementing the roam test module 12 in order to control the WLC 8 to control the APs 6. In preparation for the roam testing, the DUT 2 is brought into sufficient proximity to the set of APs 6 so that, if any AP is operating normally it could communicate with the DUT 2. In other words, the DUT 2 is within the effective communication range of each AP 6 that is to participate in the roam testing. For effective testing, there must be at least two APs thusly capable of communicating with the DUT 2. During the testing, the DUT 2 is not moved about, but instead remains stationary. The DUT 2 is also set up to be able to communicate wirelessly via the 802.11 compliant wireless protocol or other communication protocol whose roam characteristics are to be tested. This means that the DUT 2 is taken out of so-called “airplane” mode (if it has such), has its wireless communication activated, is logged into the wireless communication system comprising the APs 6 and WLC 8 including performing any password-based login or other authentication needed to enable communication with the APs 6. After these preparatory operations are complete, in an operation 20, the roam test module 12 is started. Next, in an operation 22, all but one of the APs 6 are disabled; this controls which AP 6 the wearable patient monitor 2 is connected to because it forces connection to the only available AP 6. Next, in an operation 24 performed at the connected AP 6 and/or the WLC 8, the connection between the wearable patient monitor 2 and the AP 6 is estimated. This estimation includes, at a minimum, recording successful establishment of the connection (or lack thereof, e.g. if a roam event fails). Optionally, the estimation of the connection may include recording other parameters such as transmit power, communication frequency, or other settings of the connected AP, signal strength from the DUT 2 at the AP, data rate for test data communication, or so forth. At the same time, at the DUT 2 the connection is also logged in a device under test (DUT) log 30 in an operation 32. The DUT log records, at a minimum, successful establishment of the connection (or lack thereof) and an identification of the connected AP. The log at the DUT may record other information such as transmit power, communication frequency, or other settings of the wireless communication interface of the DUT 2, strength of the AP signal at the DUT 2, data rate for test data communication, or so forth.

For explanatory purposes, the AP of the set of APs 6 that is active and connected with the DUT in the operation 22 is referred to as the “active AP.” The operations 24, 32 record characteristics of this connection at the AP 6/WLC 8 and at the DUT 2, respectively. It should be noted that while both logs 24, 32 are preferably acquired, it is alternatively contemplated to acquire only one of these logs as the data collected by the roam test: either acquiring only the AP/WLC log 24, or only the DUT log 32.

Next, in an operation 26, a roam event is triggered by deactivating the active AP that was connected in the operation 22 and activating a second AP (referred to hereafter as the “second AP”) that is different from the active AP that was connected in operation 22. The activation/deactivation operations can be performed in various ways. In one approach, the roam event is triggered by disabling the currently active AP and concurrently enabling the second AP 6 (this approach is referred to herein as a “forced roam” event). In another trigger approach, the active AP is left enabled, but its transmit (Tx) power is lowered and/or the Tx power of the “roam target”, i.e. second AP, is raised until the patient monitor 2 switches to the stronger signal provided by the second AP (this approach is referred to herein as an “opportunistic roam” event). Besides the forced roam and opportunistic roam, a skilled artisan will appreciate that other approaches to trigger roam events are possible.

The operation 26 produces a roam event, i.e. a handoff of the DUT 2 from the active AP connected in operation 22 to the second AP, because the deactivation of the former and activation of the latter causes the DUT 2 to switch to the only available AP with sufficient signal in accordance with the automated roaming architecture of the IEEE 802.11 compliant wireless communication protocol (or in accordance with automated roaming architecture of another distributed wireless communication protocol under test). No other AP is active (as per operation 22), so the handoff is necessarily from the active AP of operation 22 which is now deactivated to the second AP which is now activated. Moreover, this handoff is caused entirely by the computer 10 controlling the APs 6 via the WLC 8, and does not entail either physically moving the DUT 2 or utilizing ancillary equipment such as RF shielding or antenna attenuators. The handoff of the wearable patient monitor 2 from the active AP of operation 22 to the second AP is logged as a new roam connection in the DUT log 30 in an operation 34, and is also logged at the AP/WLC in an operation analogous to the operation 24. It should be noted that the login operations 24, 32, 34 are typically performed automatically be the respective devices. For example, an existing feature of most 802.11-equipped mobile devices running Linux is the WPA_CLI front-end which maintains an event log of all roam events. Wireless 802.11 compliant communication interfaces running other operating systems typically include analogous wireless communication logging processes.

If more roam tests are desired then, in an operation 28, the method may return to operation 22. This entails disabling all APs except the current active AP, which is the AP labeled the “second AP” in describing operation 26. Alternatively, if the operation 26 entails disabling the previous active AP (that is, disabling the AP that was activated in the operation 22) then the state of the system at completion of the operation 26 is that precisely one AP is active (namely the AP labeled as the “second AP” when describing trigger operation 26) and so process flow could go directly back to the operation 26 to perform the next roam event. After all roam events to be tested are performed, the patient monitor 2 is connected with the computer via a USB port and the WPA_CLI event log (or other DUT wireless communication log) is read (operation 40) and time synchronized with WLC events recorded in the AP/WLC log or with the instructions sent to the AP by the roam test module 12 (operation 42). This results in a detailed record of the roaming test including both the operations performed by the APs 6 under control of the WLC and the responses generated at the mobile patient monitor. As an alternative to a USB connection, any other type of connection (e.g. wireless) may be used. This produces the roam testing results in an operation 44. In one aspect, both the DUT log 30 and the WLC log are each individually sufficient to analyze the roaming test results.

The roaming test systems described herein can be implemented entirely in software, as a script running on, for example, the computer 10 in communication with the WLC 8. The patient monitor is left stationary. Additionally, the roaming test systems described herein can be used for various purposes, such as stress tests (performing thousands of roam events and recording statistics), testing performance of a new 802.11 chipset, determining relative AP signal strengths at the DUT required to trigger a handoff, and so forth. Particularly, a stress test may involve 3,000-4,000 roam events. Its use in a hospital setting would typically involve taking the 802.11 wireless network off-line, since script operation disables most APs during the testing. Although the above descriptions have been made with reference to an 802.11 wireless network, it will be appreciated that the systems and methods described herein are applicable to any other types of networks and protocols. Similarly, while the illustrative examples pertain to a medical device, e.g. the illustrative wireless patient monitor 2, the disclosed techniques could also be used to test wireless communication including roaming of other wireless devices, such as portable computers, tablet or slate computers, or so forth.

It will be further appreciated that the systems and methods disclosed herein may be embodied by a non-transitory storage medium storing instructions readable and executable by an electronic data processing device (such as the computer 10) to perform the disclosed techniques. Such a non-transitory storage medium may comprise a hard drive or other magnetic storage medium, an optical disk or other optical storage medium, a cloud-based storage medium such as a RAID disk array, flash memory or other non-volatile electronic storage medium, or so forth.

Of course, modifications and alterations will occur to others upon reading and understanding the preceding description. It is intended that the invention be construed as including all such modifications and alterations insofar as they come within the scope of the appended claims or the equivalents thereof.

1. A non-transitory storage medium storing instructions readable and executable by a computer in communication with a wireless local area network controller (WLC) controlling a plurality of wireless access points (APs) to perform a roam test method including the operations of:
(i) deactivating all but an active AP of the plurality of APs;
(ii) connecting a wireless medical device under test (DUT) with the active AP; and
(iii) triggering a roam event by operations including:
connecting the DUT with a second AP that is different from the active AP of operation (i); and
making the second AP the active AP.

2. The non-transitory storage medium of claim 1, wherein the triggering operation (iii) further includes:
enabling the second AP; and
disabling the active AP.

3. The non-transitory storage medium of claim 1, wherein the triggering operation (iii) further includes:
increasing transmit power of the second AP; and
reducing transmit power of the active AP.

4. The non-transitory storage medium of claim 1, wherein the DUT logs connection events and roam events and the roam test method includes the further operation of:
receiving log information of the roam event from the DUT at the computer executing the stored instructions.

5. The non-transitory storage medium of claim 1, wherein the AP activation and deactivation operations are performed by controlling the WLC to control the plurality of APs.

6. (canceled)

7. The non-transitory storage medium of claim 1, wherein the roam test method further includes performing a plurality of roam events by activating and deactivating APs.

8. The non-transitory storage medium of claim 1, wherein the connecting operations comprise connecting the DUT with the active AP in operation (ii), and with the second AP in operation (iii), via an Institute of Electrical and Electronic Engineers (IEEE) 802.11 compliant wireless communication.

9. The non-transitory storage medium of claim 1, wherein the operations (i), (ii), and (iii) are performed by controlling the WLC using the computer executing the instructions and are not performed by moving the DUT.

10. The non-transitory storage medium of claim 9, wherein the DUT is configured to connect to an AP based on the transmit power of the AP, and the operations (i), (ii), and (iii) are performed by adjusting transmit powers of the APs of the plurality of APs.

11. (canceled)

12. A roaming test method, comprising:
(i) deactivating all but an active wireless access point (AP) of a plurality of APs;
(ii) connecting a wireless medical device under test (DUT) with the active AP; and
(iii) triggering a roam event including:
connecting the DUT with a second AP of the plurality of APs that is different from the active AP of operation (i); and
deactivating the active AP of operation (i) thereby making the second AP the active AP.

13. The roaming test method of claim 12, wherein the triggering includes:
prior to connecting the DUT with the second AP, enabling the second AP; and
disabling the active AP.

14. The roaming test method of claim 12, wherein the triggering includes:
increasing transmit power of the second AP; and
reducing transmit power of the active AP of operation (i);
wherein the increasing and the reducing are effective to cause handoff of the DUT from the active AP of operation (i) to the second AP.

15. (canceled)

16. (canceled)

17. The roaming test method of claim 12 further comprising repeating operation (iii) to perform a plurality of roam events; and
wherein the operations (i), (ii), and (iii) are performed by a computer communicating with a wireless local area network controller (WLC) to control the plurality of APs, and the roaming test method further comprises:
after performing the plurality of roam events, downloading a record of the plurality of roam events in a wireless communication log of the DUT to the computer.

18. A wireless medical communication test system comprising:
a plurality of wireless access points (APs);
a wireless medical device under test (DUT) configured to send and receive information via the plurality of APs using Institute of Electrical and Electronic Engineers (IEEE) 802.11 compliant communication, and further configured to log roam information;
a wireless local area network controller (WLC) configured to control the plurality of APs; and
a computer configured to control the WLC to perform operations including:
through the WLC, deactivate all APs of the plurality of APs except an active AP of the plurality of APs whereby the DUT connects with the active AP;
through the WLC, controlling the APs to trigger a roam event in which the DUT hands off from the active AP to a second AP different from the active AP; and
storing information on the triggered roam event acquired from at least one of the DUT and the WLC.

19. (canceled)

20. (canceled)

21. The wireless medical communication test system of claim 18 wherein the triggering of a roam event is repeated between 2,000 and 3,000 to create a roam event log comprising the stored information on the triggered roam events.
